(19) United States
(12) Patent Application Publication
(10) Pub. No.: US 2016/0280531 A1
(43) Pub. Date: Sep. 29, 2016

(54) PLUNGER TUBE CONNECTOR FOR A CONTAINER FOR PACKAGING A PRODUCT, PARTICULARLY A CHEMICAL PRODUCT

(71) Applicant: ARKEMA FRANCE, Colombes (FR)

(72) Inventors: Julien DORMEVAL, Pau (FR); Thierry FOUILLET, Sauvagnon (FR); Patrick CHARLES, Sauvagnon (FR)

(73) Assignee: Arkema France, Colombes (FR)

(21) Appl. No.: 14/777,960

(22) PCT Filed: Mar. 17, 2014
(86) PCT No.: PCT/EP2014/055324

§ 371 Date: Sep. 17, 2015

(30) Foreign Application Priority Data
Mar. 18, 2013 (FR) 1352368

(51) Int. Cl. B67D 7/00; F16L 19/065; B67D 1/08

(52) U.S. Cl. CPC B67D 7/005; B67D 1/0829; F16L 19/065

(57) ABSTRACT

The plunger tube connector for a container for packaging a product, particularly a chemical product, comprises a body provided with a through-bore for the passage of the plunger tube, a gripping means mounted on the body and provided with an opening for the passage of said plunger tube, and a compression ring arranged axially at least in part between the body and the gripping means, and comprising a surface of contact with an outer surface of the plunger tube. The compression ring interacts with the body and/or the gripping means in order, when said body and said gripping means are brought closer to one another axially, to obtain a radial shift of said ring towards the inside.

The present invention relates to the field of the containers for packaging products, particularly chemical products.

More particularly, the present invention relates to a plunger tube connector for a container for packaging a product, particularly a toxic and/or harmful and/or odorous and/or inflammable chemical product. “Packaging” means storing the product in a container allowing the transport and the preservation, before opening, of the physicochemical structure of said product for a relatively long duration, for example approximately several months.

Such a packaging container is generally associated with a plunger tube for the filling or emptying thereof. The plunger tube forms a conduit for inserting or distributing the product.

Conventionally, for filling or emptying, the cap of the container is removed and the plunger tube is inserted inside the container. This is referred to then as an open-top container. For emptying, the lower end of the plunger tube can, for example, be brought to bear on or be at a very small distance from the bottom of the container in order to be able to distribute all of the product.

With such a process, the user of the container can be in direct contact with the product. Furthermore, the user can also be in contact with the fumes of the product. This can be especially problematic, particularly when the product is a toxic and/or harmful and/or odorous and/or inflammable product.

The aim of the present invention is to overcome these disadvantages.

More particularly, the aim of the present invention is to provide a plunger tube connector for a container for packaging a product, particularly a chemical product, for mounting the plunger tube on the container in an easy and safe manner.

It is also the aim of the invention to provide a connector allowing an adjustment of the height of the plunger tube and locking of said tube in position after adjustment.

The present invention finally relates to a connector having a simple and economical design.

In an embodiment, the plunger tube connector for a container for packaging a product, particularly a chemical product, comprises a body provided with a through-bore for passage of the plunger tube, a tightening means mounted on the body and provided with an opening for passage of said plunger tube, and a compression ring arranged axially at least partially between the body and the tightening means and comprising a surface for contact with an external surface of the plunger tube. Said compression ring engages the body and/or the tightening means in order to obtain, when bringing said body and said tightening means closer to one another in a relative axial manner, an inward radial movement of said ring.

With the connector, it is possible to insert the plunger tube into the associated container without it being necessary to completely open the upper part of the container. Indeed, the body of the device can be connected directly or indirectly via an additional element at an opening of the container having a diameter that is substantially greater than that of the plunger tube. Therefore, this reduces the risk of direct contact between the product stored in the container and the user and the risk of inhalation of the fumes of the product.

Furthermore, with the connector, it is possible to slide the plunger tube through said device until it reaches the desired position inside the container, then lock the height thereof in a particularly easy manner.

To insert the plunger tube inside the device and adjust the height, it is sufficient to position the body and the tightening means in a spaced-apart position wherein the compression ring does not axially block the insertion and sliding of the plunger tube. Under these conditions, the plunger tube can be inserted and slide inside the device as a result of simple axial pushing.

Then, the positional locking of the plunger tube is easily obtained by bringing the body and the tightening means closer to one another in a relative axial manner. Indeed, bringing them closer to one another causes an inward radial movement of the compression ring, which allows a radial compression of the external surface of the plunger tube to be obtained. The compression ring exerts a substantially radial force directed inwards such as to radially compress the external surface of the plunger tube and prevent said tube and the connector from being axially detached. The compression ring forms a means of axially locking the plunger tube in relation to the body and to the tightening means of the device.

The device also has the advantage of allowing easy dismounting of the plunger tube, for example, to reposition it at a different height inside the container, or to replace it, or to use the device and the plunger tube on another container with different dimensions and/or volume. To this end, the tightening means should be moved relative to the body in the spaced-apart position wherein the compression ring is not radially urged inwards.

Preferably, the body and the tightening means define an axial space inside which the compression ring is housed. The compression ring is, therefore, held axially between the body and the tightening means. This arrangement allows for the prevention of a possible axial detachment of the compression ring with respect to the other elements forming the connector. The device forms a unitary assembly which can be handled, transported and mounted with a particularly limited risk of accidental separation of the constituent elements.

Advantageously, the contact surface of the compression ring is continuous in the circumferential direction. The possible infiltration of liquid or gas between the plunger tube and the compression ring is therefore greatly reduced.

In an embodiment, the body or tightening means comprises a truncated portion to obtain the inward radial movement of the compression ring when bringing the body and the adjusting means closer to one another in a relative axial manner. This arrangement allows the inward radial movement of the compression ring to be obtained simply and effectively during axial urging of said ring by the body and/or the adjusting means.

The compression ring can also comprise a truncated external surface engaging the truncated portion of the body or of the tightening means and radially opposite the contact surface.

According to another feature, the compression ring can comprise a centering portion arranged inside the tightening means and a retaining portion axially extending said centering portion. The truncated external portion of the compression ring can be provided on the retaining portion.

In an embodiment, the compression ring is made from synthetic material, particularly from PTFE. In an alternative, the compression ring can be made from metal or from a metal alloy that is elastically deformable, for example copper.

Preferably, the tightening means is mounted on the external surface of the body, particularly by means of screwing.

In an advantageous embodiment, the device further comprises a sealing plug mounted on the body and intended to seal a bunghole of the associated packaging container. Therefore, the connector allows, furthermore, the bunghole of the container to be sealed. The device, therefore, allows a double function to be provided, namely the mounting and locking of the plunger tube, firstly, and the plugging of the bunghole of the associated container, secondly.

The sealing plug can be mounted on the external surface of the body, particularly by means of screwing. The sealing plug can also comprise fixing means intended to engage the bunghole of the packaging container.

In an embodiment, the body, the tightening means and the sealing member are made from metal, particularly from steel.

The invention also relates to a packaging container containing a product, particularly a chemical product, and comprising at least a bunghole, a connector as defined above which is mounted at the bunghole, and a plunger tube passing through the connector and extending inside the container.

The present invention will be better understood upon studying the detailed description of an embodiment taken by way of nonlimiting example and illustrated by the appended drawings, wherein:

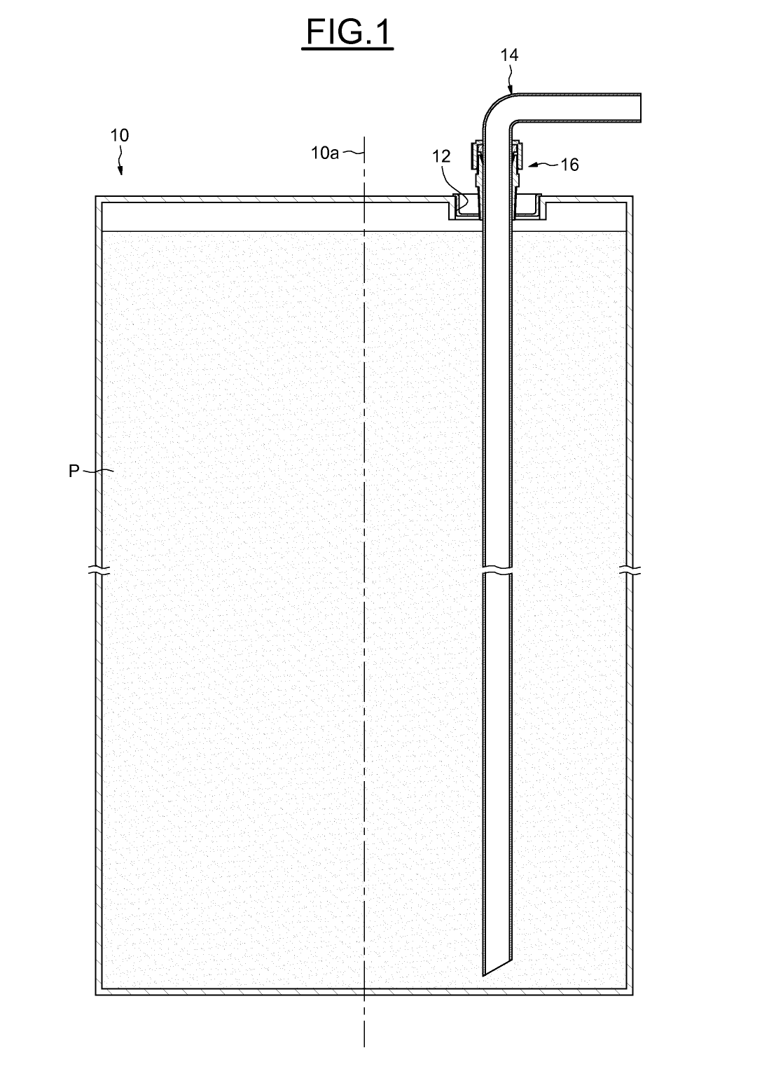

FIG. 1 is a cross section view of a container comprising a connector according to an embodiment,

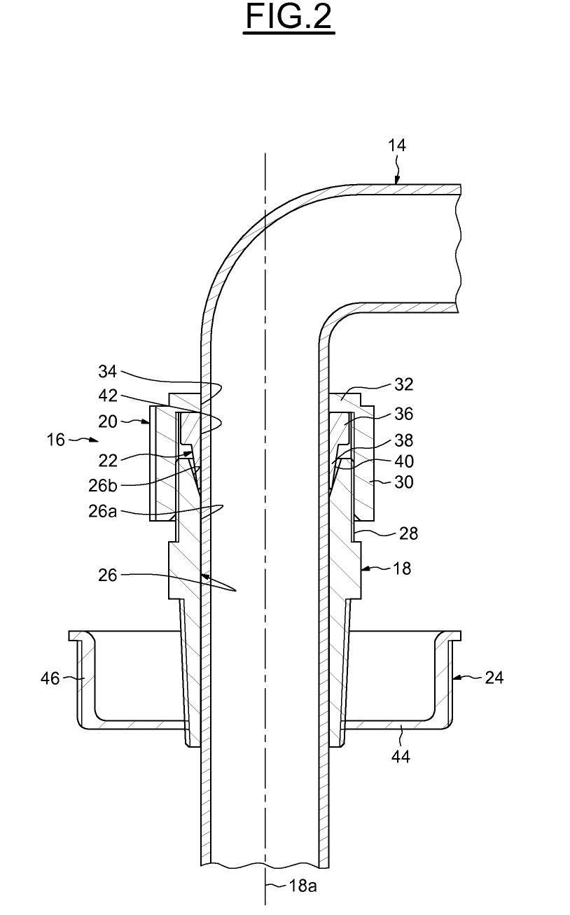

FIG. 2 is a cross section view of the connector of FIG. 1, and

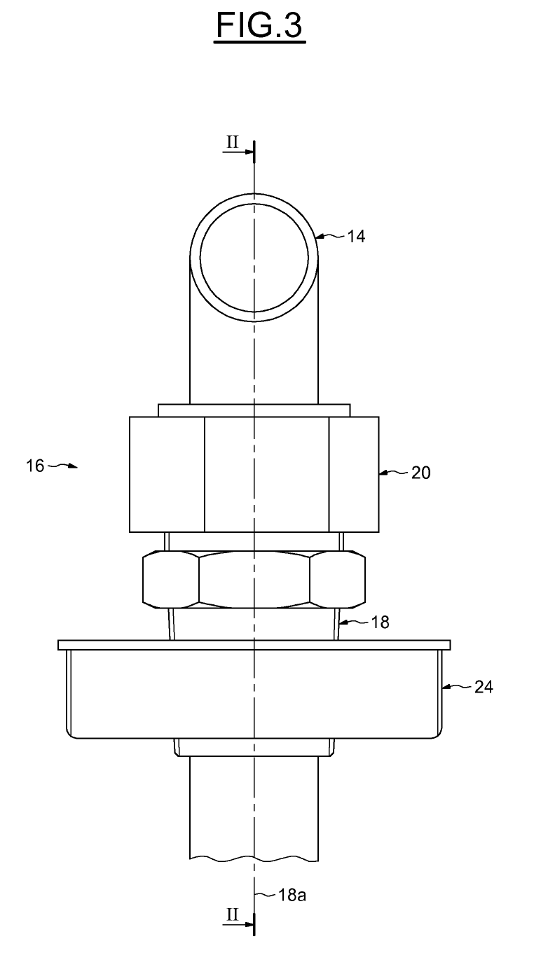

FIG. 3 is a front view of the connector of FIGS. 1 and 2.

FIG. 1 shows a container designated by the general numeric reference 10 in a supposed vertical position. In the envisaged use, the container 10, with axis 10a, is intended to package one or more toxic and/or harmful and/or odorous and/or inflammable chemical products P. The container 10 can, of course, be used to package other types of chemical or other products.

The container 10 comprises, at the upper end thereof, a bunghole 12, a plunger tube 14 extending inside the container and out of said container, and a connector 16 mounted at the bunghole 12 and through which the plunger tube 14 extends. As will be described in greater detail below, the connector 16 is provided to allow the plunger tube 14 to slide inside the container 10 and said tube to be locked in position. The plunger tube 14 allows the container 10 to be filled and/or emptied.

The container 10 also comprises, at the upper end thereof, an additional bunghole (not shown) provided for pressure equalization when filling or emptying the container. This additional bunghole can be provided with a simple odor filter or with a gas adsorber, or a hose connected to a pump or to a compressor such that it is possible to create the pressure or low pressure necessary inside the container for emptying or filling, respectively.

As illustrated more visibly in FIGS. 2 and 3, the connector 16 comprises a body 18, with axis 18a, a tightening nut 20 mounted on the body, a compression ring 22 mounted axially between the body and the tightening nut, and a sealing plug 24 for closing the bunghole of the container.

The body 18 comprises a bore 26 axially passing straight through said body for passage of the plunger tube. The bore 26 is formed by a cylindrical portion 26a coaxial with the axis 18a and extending axially from the lower end of the body 18, and by a truncated portion 26b extending said cylindrical portion and flaring outwards. The truncated portion 26b opens at the upper end of the body 18. The body 18 comprises an external surface 28 on which is provided, from an upper end, a first thread (not referenced) for fixing and screwing the tightening nut 20. In the illustrated embodiment, the body 18 has a tubular general shape. In an alternative, the body 18 could have a curved shape.

The tightening nut 20 comprises an annular axial tightening part 30 internally comprising a thread (not referenced) engaging the thread of the body 18. The tightening part 30 externally comprises six flats such as to allow the nut 20 to be tightened with a wrench. The tightening part 30 is extended, at an axial end located on the side opposite the body 18, by a radial wall 32 comprising a through-opening 34 for passage of the plunger tube 14 and that is coaxial with the axis 18a. The nut 20 and the body 18 define an axial space inside which the compression ring 22 is entirely mounted.

The annular compression ring 22 is advantageously made as one piece by molding a synthetic plastic, for example PTFE. The compression ring 22 is elastically deformable. The ring 22 comprises an annular centering portion 36 and an annular retaining portion 38 axially extending said centering portion. The centering portion 36 is radially centered inside the tightening part 30 of the nut and is axially mounted in a bearing manner against the radial wall 32 of said nut. The retaining portion 38 is mounted partially inside the truncated portion 26b of the bore of the body 18 and bears against said portion. The retaining portion 38 has a truncated external surface 40 substantially matching the shape of the truncated portion 26b of the bore. The external surface 40 is in contact with said truncated portion 26b.

The compression ring 22 comprises an internal surface 42 provided to come into contact with the external surface of the plunger tube. The internal surface 42 is radially opposite the truncated external surface 40. The internal surface 42 forms the compression ring bore which is coaxial with the axis 18a and extends along the centering 36 and retaining 38 portions. The internal surface 42 is annular, i.e. continuous in the circumferential direction. As will be described in greater detail below, when the nut 20 is screwed onto the body 18, the axial urging force exerted by the nut on the compression ring 22 allows said ring to radially compress the external surface of the plunger tube 14 and axially lock the tube.

The sealing plug 24 is mounted by means of screwing on the external surface 28 of the body axially on the side opposite the tightening nut 20. To this end, a second thread (not referenced) is provided on the external surface 28 of the body 18 and engages a thread (not referenced) of the plug 24. The plug 24 allows the bunghole 12 (FIG. 1) of the container to be sealed. In the illustrated embodiment, the plug 24 has a cup shape. The plug 24 comprises a radial wall 42 comprising a threaded bore which is screwed onto the body 18 and an axial portion 44 extending a large-diameter edge of said radial portion. The axial portion 44 comprises, on the external surface thereof, a thread (not referenced) provided to engage the thread of the bunghole 12 in order to fix the device 16 on the associated container 10.

After fixing the device 16 on the container 10, the following steps are taken in order to insert the plunger tube 14 inside the device, then to adjust the height of and lock said tube.

In a first step, the nut 20 is slightly unscrewed such that the compression ring 22 is not axially urged by said nut. The thread of the nut 20 remains engaged with the thread of the body 18. Then, during a second step, the plunger tube 14 is inserted inside the opening 34 of the nut, the internal surface 42 of the compression ring and the bore 26 of the body. The plunger tube 14 slides through the connector 16 and inside the container 10 until the lower end of said tube reaches the desired position, for example bearing on or at an extremely small axial distance from the bottom of the container.

In a third step, the tightening nut 20 is screwed onto the body 18 such as to axially bring the radial wall 32 of the nut and the body 18 closer to one another. Axially bringing the nut 20 closer in relation to the body 18 causes the axial movement of the compression ring 22 in the direction of the body 18 and against the truncated portion 26b of the bore of said nut, and an inward radial deformation of the retaining portion 38 of the ring by means of said truncated portion 26b. The retaining portion 38 of the compression ring deforms radially towards the external surface of the plunger tube 14 and radially compresses said surface. The internal surface 42 of the compression ring comes, at least on part of the length thereof, radially into contact with the external surface of the plunger tube 14 and radially clamps said surface. Therefore, the plunger tube 14 is axially locked in relation to the connector 16 as a result of the compression ring 22 jamming said tube.

In the illustrated embodiment, the nut 20 is screwed onto the external surface of the body 18. In an alternative, it is possible to screw the nut inside the body 18. However, with such a design, it is necessary to provide a larger axial dimension for the compression ring 22. In another alternative embodiment, it is possible to provide a compression ring that is entirely conical and/or to provide on the contact internal surface 42 teeth radially projecting inwards, the aim of which is to help the ring catch on the external surface of the pipe.

In the illustrated embodiment, the radial deformation of the compression ring 22 allowing the axial locking of the plunger tube 14 is obtained thanks to the axial movement of the nut 20 and of the compression ring 22, and to the engagement of the retaining portion 38 of said ring and the truncated portion 26b of the bore of the body. The compression ring 22 therefore engages both the nut 20 and the body 18 in order to radially clamp the plunger tube 14.

In another alternative embodiment, it is possible to mount the centering portion 36 of the compression ring axially to bear against the upper end of the body 18 and provide on the radial wall 32 of the nut 20 a truncated opening 34 that can engage the retaining part 38 of the ring. Under these conditions, when bringing the nut 20 and the body 18 closer to one another in a relative axial manner, the movement of the nut causes the inward radial deformation of the compression ring 22. Therefore, when bringing the nut 20 and the body 18 closer to one another in a relative axial manner, only the nut engages the compression ring 22 in order to axially lock the plunger tube 14.

In the illustrated embodiment, the sealing plug 24 is removably mounted on the body 18 by means of screwing. In an alternative, it is possible to fix the plug 24 on the body 18 such that it cannot be dismounted, for example by welding. However, the removable mounting of the plug 24 is advantageous insofar as plugs of various diameters can then be mounted on a same body 18. The diameter of the plug 24 is chosen according to the diameter of the bunghole of the associated container. Therefore, it is possible to use a single body 18, a single nut 20 and a single ring 22 for containers having bungholes with different diameters. Moreover, the elastic nature of the compression ring 22 also allows an adaptability to various diameters of plunger tubes.

The invention provides a connector for easily and quickly adjusting the height of the associated plunger tube and locking said tube, and providing a good level of impermeability to liquids and gases.

The connector of the invention is particularly suitable for filling and emptying toxic and/or harmful and/or odorous and/or inflammable products, in particular for the liquid chemical products transported and/or stored in containers which can be filled or emptied by applying pressure or low pressure. The connector of the invention is particularly suitable for crop protection products, particularly used for open field farming, in particular for fumigants, and more particularly for disulfides, for example dimethyl disulfide, for halides, for example methyl bromide, 1,3-dichloropropene or chloropicrin (Cl₃C—NO₂), but also metam sodium (CH₃—NH—CS₂⁻Na⁺), metam potassium (CH₃—NH—CS₂⁻K⁺) or sodium tetrathiocarbonate (Na₂CS₄), and methyl isothiocyanate (MITC or CH₃—NCS) and the MITC precursors, for example dazomet, alone or in mixtures of two or more therefrom in any proportions.

1. A plunger tube connector for a container for packaging a product, wherein the plunger tube connector comprises:
a body provided with a through-bore for passage of a plunger tube,
a tightening means mounted on the body and provided with an opening for passage of said plunger tube, and
a compression ring arranged axially at least partially between the body and the tightening means and comprising a contact surface for contact with an external surface of the plunger tube, said compression ring engaging the body and/or the tightening means in order to obtain, when bringing said body and said tightening means closer to one another in a relative axial manner, an inward radial movement of said compression ring.

2. The plunger tube connector as claimed in claim 1, wherein the body and the tightening means define an axial space inside which the compression ring is housed.

3. The plunger tube connector as claimed in claim 1, wherein the contact surface of the compression ring is continuous in the circumferential direction.

4. The plunger tube connector as claimed in claim 1, wherein the body or the tightening means comprises a truncated portion to obtain the inward radial movement of the compression ring when bringing the body and the adjusting means closer to one another in a relative axial manner.

5. The plunger tube connector as claimed in claim 4, wherein the compression comprises a truncated external surface engaging the truncated portion of the body or of the tightening means and radially opposite the contact surface.

6. The plunger tube connector as claimed in claim 1, wherein the compression ring comprises a centering portion arranged inside the tightening means and a retaining portion axially extending said centering portion.

7. The plunger tube connector as claimed in claim 6, wherein the truncated external surface of the compression ring is provided on the retaining portion.

8. The plunger tube connector as claimed in claim 1, wherein the compression ring is made from synthetic material.

9. The plunger tube connector as claimed in claim 1, wherein the tightening means is mounted on the external surface of the body.

10. The plunger tube connector as claimed in claim 1, further comprising a sealing plug mounted on the body and configured to seal a bunghole of the associated packaging container.

11. The plunger tube connector as claimed in claim 10, wherein the sealing plug is mounted on the external surface of the body.

12. The plunger tube connector as claimed in claim 11, wherein the sealing plug comprises fixing means configured to engage the bunghole of the packaging container.

13. A packaging container containing a product, and comprising at least a bunghole, a plunger tube connector as claimed in claim 1, which is mounted at the bunghole, and a plunger tube passing through the plunger tube connector and extending inside the container.

14. The plunger tube connector as claimed in claim 1, wherein the product is a chemical product.

15. The plunger tube connector as claimed in claim 1, wherein the compression ring is made from PTFE.

16. The plunger tube connector as claimed in claim 1, wherein the tightening means is mounted on the external surface of the body by means of screwing.

17. The plunger tube connector as claimed in claim 10, wherein the sealing plug is mounted on the external surface of the body by means of screwing.

18. The packaging container of claim 13, wherein the product is a chemical product.
